(19) United States
(12) Patent Application Publication
(10) Pub. No.: US 2004/0212978 A1
(43) Pub. Date: Oct. 28, 2004

(54) Light guide plate with pattern-dots and backlight system using the same

(76) Inventors: Tai-Cherng Yu, Tu-Chen (TW); Ga-Lane Chen, Fremont, CA (US); Charles Leu, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/832,793

(22) Filed: Apr. 26, 2004

(30) Foreign Application Priority Data
Apr. 25, 2003 (TW) 92109677

(51) Int. Cl. G01D 11/28

(52) U.S. Cl. 362/26; 362/31; 362/330

(57) ABSTRACT

A light guide plate (200) for use in a backlight system includes a light incident surface (201), a light exit surface (202), and a bottom surface (203) opposite to the light exit surface. The bottom surface has a multiplicity of hemispherical pattern-dots (204) provided thereon, which are arranged in a regular manner. A projection of each pattern-dot on the bottom surface is circular, and each pattern-dot has a height (D) less than a radius (r) of the circle. Preferably, a height-to-radius ratio of each pattern-dot varies in the range from 0.067˜0.86. Thus the brightness of light beams transmitting out from the light exit surface is enhanced. Other embodiments of the light guide plate are also detailed herein.

### BACKROUND OF THE INVENTION

1. Field of the Invention

The present invention relates to a light source device for use in a liquid crystal display (LCD), and particularly to a light guide plate and a backlight system using the same.

2. Description of Prior Art

A typical LCD device comprises a liquid crystal display panel and a backlight system mounted under the liquid crystal display panel for supplying light beams thereto. The backlight system mainly comprises a light source and a light guide plate. The light guide plate is made of a transparent acrylic plastic, and is used for guiding the light beams emitted by the light source to uniformly illuminate the liquid crystal display panel.

The light source emits light beams into the light guide plate, in which the light beams are liable to be totally internally reflected. In order to diffuse the light beams and emit them uniformly from a top surface of the light guide plate, protrusions or recesses are provided on a bottom surface of the light guide plate. Alternatively, a pattern of light diffusion dots is formed on the bottom surface of the light guide plate.

Referring to FIGS. 6-8, various schematic views of a conventional light guide plate 12 and a related art backlight system 1 are shown. The backlight system 1 includes a light source 11, a light source cover 111, a light guide plate 12, a reflective plate 13, a diffusion sheet 14, and a pair of prism sheets 15.

The light guide plate 12 has a bottom surface 120, and a multiplicity of dots 121 is disposed on the bottom surface 120.

In assembly, the light source 11 is positioned adjacent to the light guide plate 12, and the light source cover 111 is placed beside the light source 11 generally opposite from the light guide plate 12. The reflective plate 13 is arranged under the light guide plate 12. The diffusion sheet 14 and the prism sheets 15 are arranged above the light guide plate 12 in that order from bottom to top.

In operation, the light source 11 emits light beams, and the light beams transmit into the light guide plate 12. The dots 121 diffuse the light beams. The reflective sheet 13 and the light source cover 111 reflect the light beams, and directs the light beams to exit from a top of the light guide plate 12. The light beams then sequentially pass through the diffusion sheet 14 and the prism sheets 15 to illuminate a liquid crystal display panel (not shown).

The dots 121 are disposed on the bottom surface 120 equidistantly from each other in a regular rectangular array. A projection of each dot 12 on the bottom surface 120 is circular. Each dot has a height D₁, which is equivalent to a radius r₁ of the circle. In practice, this configuration results in the light guide plate 12 transmitting light beams with a relatively low brightness.

### SUMMARY OF THE INVENTION

An object of the present invention is to provide a light guide plate for use in a backlight system, with the light guide plate yielding high brightness.

A light guide plate in accordance with the present invention includes a light incident surface, a light exit surface, and a bottom surface opposite to the light exit surface. The bottom surface has a multiplicity of hemispherical pattern-dots provided thereon, which are arranged in a regular array. A projection of each pattern-dot on the bottom surface is circular, and each pattern-dot has a height less than a radius of the circle. Preferably, a height-to-radius ratio of each pattern-dot varies in the range from 0.067˜0.86. Thus the brightness of light beams transmitting out from the light exit surface is enhanced. Other embodiments of the light guide plate are also detailed herein.

Other objects, advantages, and novel features of the present invention will become more apparent from the following detailed description when taken in conjunction with the accompanying drawings.

### BRIEF DESCRIPTION OF THE DRAWINGS

FIG. 1 is an isometric view of a light guide plate according to a first embodiment of the present invention.

FIG. 2 is a front elevation of the light guide plate of FIG. 1.

FIG. 3 is an enlarged view of a circled portion III of FIG. 2.

FIG. 4 is an isometric view of a light guide plate according to a second embodiment of the present invention.

FIG. 5 is a schematic, front elevation of a backlight system incorporating the light guide plate of FIG. 2.

FIG. 6 is an exploded, front elevation of a backlight system incorporating a conventional light guide plate, showing light paths thereof.

FIG. 7 is an isometric view of the light guide plate of FIG. 6, but viewed from a bottom aspect.

FIG. 8 is an enlarged view of a circled portion VIII of FIG. 6.

### DETAILED DESCRIPTION OF THE PRESENT INVENTION

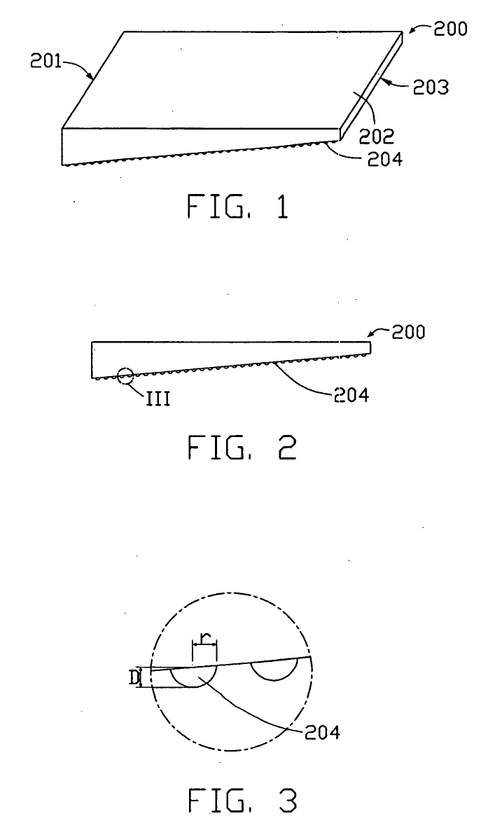

Referring to FIGS. 1-2, two views of a light guide plate 200 according to the first embodiment of the present invention are shown. The light guide plate 200 is wedge-shaped, and includes a light incident surface 201, a light exit surface 202 adjoining the light incident surface 201, and a bottom surface 203 opposite to the light incident surface 201.

The light guide plate 200 comprises a multiplicity of pattern-dots 204, which are manufactured by a printing method. Alternatively, the pattern-dots 204 can be manufactured by a molding projection method. The pattern-dots 204 are arranged on the bottom surface 203 in a regular rectangular array. A distribution density of the pattern-dots 204 increases with increasing distance away from the light incident surface 201.

Turning to FIG. 3, each pattern-dot 204 is substantially hemispherical, and has a height D. A projection of each pattern-dot 204 on the bottom surface 203 is circular, and the circle has a radius r.

A brightness of light beams transmitting out from the light exit surface 202 changes according to a height-to-radius ratio D/r of the pattern-dots 204. In particular, the brightness increases when the height-to-radius ratio D/r varies in the range from 0.037˜0.92, preferred in the range from 0.067˜0.86.

Compared with the conventional light guide plate 12 described above, each pattern-dot 204 according to the present invention has the height D which is less than the radius r of the circular projection. With this structure, the brightness of light beams transmitting out from the light exit surface 202 is enhanced.

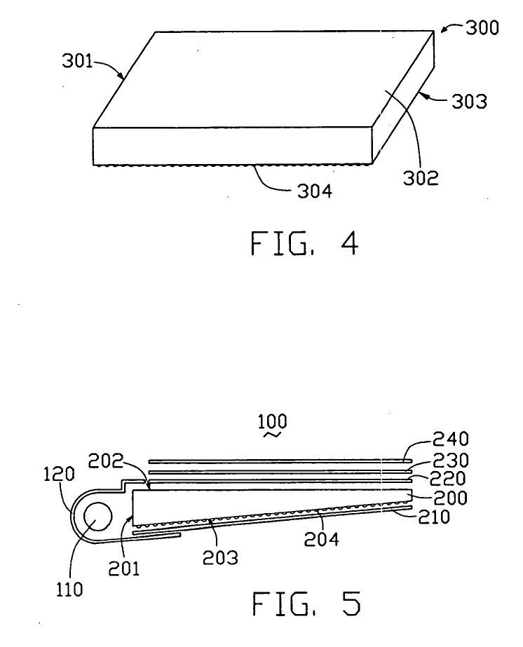

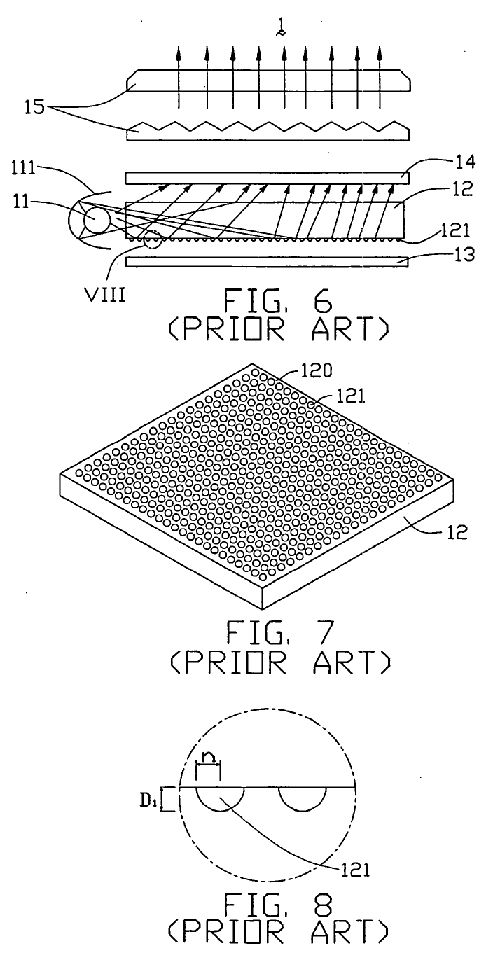

Referring to FIG. 4, an isometric view of a second embodiment of a light guide plate according to the second embodiment of the present invention are shown. The light guide plate 300 is substantially rectangular and has a uniform thickness. The light guide plate 300 includes a light incident surface 301, a light exit surface 302 adjoining the light incident surface 301, and a bottom surface 303 opposite to the light incident surface 301.

The light guide plate 300 comprises an array of pattern-dots 304 on the bottom surface 303 thereof. The pattern-dots 304 are arranged on the bottom surface 303 non-uniformly. A size of each pattern-dot 304 increases with increasing distance away from the light incident surface 301. Similar to the pattern-dots 204, each pattern dot 304 is substantially hemispherical, and has a height less than a radius of a circular projection on the bottom surface 303. A height-to-radius ratio of each pattern-dot 304 is predetermined. The ratio can vary in the range from 0.037˜0.92, and preferably in the range from 0.067˜0.86.

Instead of being hemispherical, the pattern-dots 204, 304 can alternatively have other shapes which have a circular projection on the bottom surface 203, 303. For example, the pattern-dots 204, 304 can be cylindrical or sub-hemispherical.

Referring to FIG. 5, a schematic view of a backlight system 100 incorporating the light guide plate 200 is shown. The backlight system 100 further comprises a light source 110, a light source cover 120, the light guide plate 200, a reflective plate 210, a diffusion sheet 220, and two prism sheets 230, 240.

The light guide plate 200 has the bottom surface 203, and the multiplicity of pattern-dots 204 disposed on the bottom surface 203.

The light source 110 is positioned adjacent to the light guide plate 200, and the light source cover 120 is placed around the light source 110 and an end portion of the light guide plate 200 at the light incident surface 201. The reflective plate 210 is arranged under the light guide plate 200. The diffusion sheet 220 and the prism sheets 230, 240 are arranged above the light guide plate 200, in that order from bottom to top.

In operation, the light source 110 emits light beams, which transmit into the light guide plate 200. The pattern-dots 204 disposed around the bottom surface 203 diffuse the light beams. The reflective sheet 210 and the light source cover 120 reflect the light beams and direct them to exit from the light exit surface 202 of the light guide plate 200. The light beams then sequentially pass through the diffusion sheet 220 and the prism sheets 230, 240 to illuminate a liquid crystal panel (not shown).

In summary, the advantage of the present invention is that the light guide plate 200, 300 has a multiplicity of diffusion pattern-dots 204, 304 with a height-to-radius ratio D/r varying in the range from 0.037˜0.92, and preferably in the range from 0.067˜0.86. Thus the brightness of light beams transmitting out from the light exit surface 202, 302 is enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate for use in a backlight system, comprising:
a light incident surface;
a light exit surface; and
a bottom surface opposite to the light exit surface, a plurality of pattern-dots being provided on the bottom surface, a projection of each pattern-dot on the bottom surface being circular, each pattern-dot having a height less than a radius of the circle.

2. The light guide plate as claimed in claim 1, wherein a height-to-radius ratio of each pattern-dot is in the range from 0.037˜0.92.

3. The light guide plate as claimed in claim 2, wherein the height-to-radius ratio is in the range from 0.067˜0.86.

4. The light guide plate as claimed in claim 1, wherein a distribution density of the pattern-dots increases with increasing distance away from the light incident surface.

5. The light guide plate as claimed in claim 1, wherein sizes of the pattern-dots increase with increasing distance away from the light incident surface.

6. The light guide plate as claimed in claim 1, wherein the pattern-dots are provided on the bottom surface in a non-uniform array.

7. The light guide plate as claimed in claim 1, wherein the pattern-dots are arranged on the bottom surface in a regular array.

8. A light guide plate comprising:
a light incident surface;
a light exit surface; and
a bottom surface opposite to the light exit surface, a plurality of pattern-dots being provided on the bottom surface; wherein
each of said pattern-dots is configured to be a portion of an ellipsoid under said bottom surface rather than a semi-sphere.

9. A light guide plate comprising:
a light incident surface;
a light exit surface; and
a bottom surface opposite to the light exit surface, a plurality of pattern-dots being provided on the bottom surface; wherein
each of said pattern-dots is configured to be a portion of an ellipse under said bottom surface rather than a semi-circle from an elevational side view.
